(19) United States
(12) Patent Application Publication
(10) Pub. No.: US 2025/0313425 A1
(43) Pub. Date: Oct. 9, 2025

(54) WEB SINGULATION FOR FEEDING ELECTRODES TO BATTERY STACKER

(71) Applicant: DWFritz Automation, LLC, Wilsonville, OR (US)

(72) Inventors: Derek Graham Aqui, Portland, OR (US); Christopher E. Barns, Tigard, OR (US); Karl Weibezahn, Keizer, OR (US); Brady L. Byers, Newberg, OR (US)

(21) Appl. No.: 19/239,758

(22) Filed: Jun. 16, 2025

Related U.S. Application Data
(63) Continuation of application No. PCT/US23/83961, filed on Dec. 14, 2023.
(60) Provisional application No. 63/387,920, filed on Dec. 16, 2022.

(51) Int. Cl. B65H 35/00; B65H 35/08; H01M 4/04

(52) U.S. Cl. CPC B65H 35/008; B65H 35/08; H01M 4/043; B65H 2301/415; B65H 2404/19; B65H 2408/24; B65H 2701/19; B65H 2701/71

(57) ABSTRACT

Disclosed are techniques for reducing out-of-plane protrusions while singulating an electrode from a web. In some embodiments, feed rollers feed perforated web material from a roll, tear and position rollers receive a portion of the perforated web material from the feed rollers, and a servo motor changes speed of at least one of the feed rollers and tear and position rollers to thereby generate a tearing force, applied to the portion of the perforated web material, that singulates the portion in a predefined shape of an electrode.

### CROSS-REFERENCE TO RELATED APPLICATION

This Application is a Continuation of PCT/US2023/083961, filed on Dec. 14, 2023, which claims the benefit of U.S. Provisional Application No. 63/387,920, filed on Dec. 16, 2022, all the content of which is hereby incorporated in their entirety.

### TECHNICAL FIELD

This disclosure generally relates to preparing electrodes for battery stacking production. In particular, this disclosure relates to electrode singulation from roll material.

### BACKGROUND INFORMATION

A web is a continuous roll of a flexible material (such as paper, film, or foil) that is in the process of being formed, converted, or printed. The web can either be cut down into sheets during the manufacturing process or sent to converters or printers in a continuous form.

Some batteries are formed by interleaving alternate layers of cathodes, insulating separators, and anodes. In z-fold embodiments, to form a stack, the separator is a continuous layer that is folded back and forth (z-fold) between the alternating anode and cathode layers. In other embodiments, discrete separator layers are employed.

The battery design itself precludes aligning the edges of individual layers to a common datum. To avoid malfunction, there should be no electrical contact between an anode and an adjacent cathode. To that end, the anode and cathode are typically mismatched in size and center-aligned to each other, such that a physical border of about three mm exists between adjacent anode and cathode layers.

Because separator layers are folded or placed between electrodes, there are specific tolerances for burs and spikes that may project from the electrode major surfaces toward the confronting separator major surfaces. Such burs and spikes are sometimes caused by processes that singulate electrodes from the web. These undesirable production defects could contact and damage the planar surface of separator material.

### BRIEF SUMMARY OF THE DISCLOSURE

By using methods and systems as disclosed herein, an electrode may be singulated from a stack by fabricating tear lines, and then tearing an electrode from a web material by applying a pressure along the fabricated tear lines.

Because a singulation force is applied along a transport direction of the web, the tension force reduces production of undesirable burs, spikes, and other major surface defects extending upward or downward along a singulation line and projecting into a planar surface, which would otherwise occur if force was applied as a cutting force through the material. For instance, knives, punches, lasers, and the like tend to produce defects/debris that protrude out of the plane of the electrode whereas the perforated and tear technique tends to produce in-plane defects, debris, or sharp edges. The perforation and tear technique also enables the perforation to be done in an upstream process, and possibly also at a different location, compared to the singulation and tearing process. This may enable a more efficient overall process, and enables the perforated web to be cleaned and/or inspected prior to the singulation process.

In addition to addressing burs and spikes projecting from a planar surface of an electrode, the perforation pattern may be optimized to protect the torn edge from being the part of the electrode that protrudes the most from a singulated electrode. This protects the possibly ragged and or sharp edge from contacting any adjacent materials. Thus, the resulting tear shape (i.e., ragged edge) may be optimized for interaction with the separator and battery density.

According to an aspect, a method of singulating electrodes is provided. The method comprises fabricating tear lines between adjacent electrodes in a web, feeding the web through a singulation device, and applying a force to the web using the singulation device, so as to tear an electrode from the web along its fabricated tear lines. In some embodiments, the fabricating of tear lines may be done at a different location than the other steps, and the web material may be transported from that location to the location of the singulation device. The applying of force may comprise running a set of tear and position rollers at a higher speed than a pair of feed rollers feeding the web material to the tear and position rollers.

According to another aspect, a singulation system for singulating an electrode from a web is provided. The system comprises feed rollers adapted to feed web material from a roll, and tear and position rollers adapted to receive a portion of the web material from the feed rollers. The system further comprises a controllable motor adapted to change speed of at least one of the feed rollers and tear and position rollers, to thereby generate a tearing force, which is applied to a fabricated tear line along the web material in order to singulate the portion of web material according to a predefined shape of an electrode.

Additional aspects and advantages will be apparent from the following detailed description of embodiments, which proceeds with reference to the accompanying drawings.

### BRIEF DESCRIPTION OF THE DRAWINGS

To easily identify the discussion of any particular element or act, the most significant digit or digits in a reference number refer to the figure number in which that element is first introduced.

FIG. 1 is an isometric view of a z-fold stacker machine, according to one embodiment.

FIG. 2 is an isometric view of a web undergoing notching, perforation, and coating, according to one embodiment.

FIG. 3 is an isometric view of a processed web being singulated, according to one embodiment.

FIG. 4 is an enlarged isometric view of a singulation device shown in FIG. 3.

FIG. 5 is an enlarged isometric view of tear and position rollers, vacuum conveyor, and picking device shown in FIG. 3.

FIG. 6 is a top plan view of a portion of a dashed shape perforation line with an enlarged pictorial view of a singulation line.

FIG. 7 is a top plan view of a portion of a scalloped shape perforation line with an enlarged pictorial view of a singulation line.

FIG. 8 is a top plan view of a portion of a trapezoidal shape perforation line with an enlarged pictorial view of a singulation line.

FIG. 9 is an isometric view of a singulation device, according to another embodiment.

### DETAILED DESCRIPTION OF EMBODIMENTS

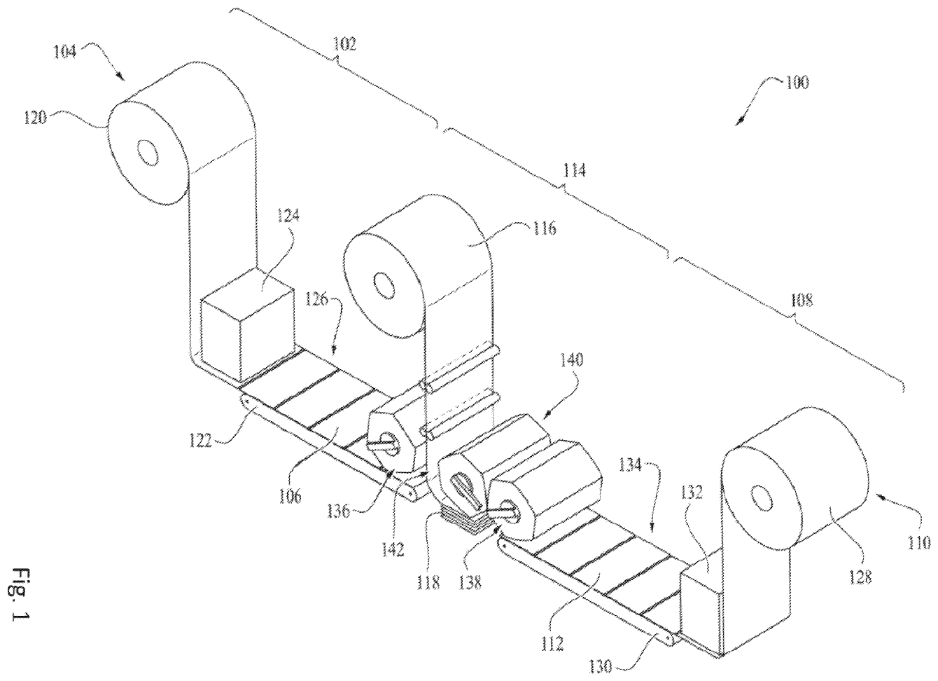

FIG. 1 shows a simplified view of a z-fold stacker machine 100, according to one embodiment. Z-fold stacker machine 100 includes a first electrode delivery system 102 for providing a first type of electrode material 104 (e.g., a copper anode 106), a second electrode delivery system 108 providing a second type of electrode material 110 (e.g., an aluminum cathode 112), and a central assembly system 114 providing a separator 116 for z-folding with the electrodes to form a battery stack 118. In a z-fold configuration, separator 116 is not singulated into discrete layers but instead forms a single continuous layer that is folded back and forth between alternating electrodes (anodes and cathodes).

In battery stack 118, copper anode 106 and aluminum cathode 112 are typically mismatched in size and center aligned to each other (i.e., with no common edge datum), such that a physical border of three mm exists between adjacent anode and cathode layers. Z-fold stacker machine 100 is designed to meet this center alignment specification, typically to an accuracy of about 0.25 mm. Z-fold stacker machine 100 can accommodate a wide range of electrode sizes.

In the example of z-fold stacker machine 100, first electrode delivery system 102 includes a first roll 120 of electrode material 104. As electrode material 104 is pulled from first roll 120 by a conveyor 122 or other transport mechanism, a singulation device 124 separates electrode material 104 to form first electrodes 126 that are singulated from first roll 120.

Likewise, second electrode delivery system 108 includes a second roll 128 of electrode material 110. As electrode material 110 is pulled from second roll 128 by a conveyor 130 or other transport mechanism, a singulation device 132 separates electrode material 110 to form second electrodes 134 that are singulated from second roll 128.

Central assembly system 114 includes three eccentrically rotatable multi-sided grippers, which are explained in further detail below. Initially, however, each eccentrically rotatable multi-sided gripper has a longitudinal axis that is offset from an axis of rotation such that the eccentrically rotatable multi-sided gripper moves about a circular path while sequentially presenting different arcuate gripper surfaces to transverse material-transfer positions.

In this example of z-fold stacker machine 100, a first eccentrically rotatable multi-sided gripper 136 and a second eccentrically rotatable multi-sided gripper 138 act as pick-and-place devices that move electrodes from horizontal positions atop respective conveyor 122 and conveyor 130 to vertical positions where they are transferrable to a central eccentrically rotatable multi-sided gripper 140 that also selectively engages a draped section 142 of separator 116. Central eccentrically rotatable multi-sided gripper 140 then places the material atop battery stack 118.

In this embodiment, separator 116 is fed along the same side as first electrodes 126, but at twice the rate, i.e., twice the length of separator per length of electrode. The unconstrained portion of the separator (between battery stack 118 and the electrode being picked) is held in tension by air pressure before it is folded onto battery stack 118 by orbital motion of central eccentrically rotatable multi-sided gripper 140. The inherent flexibility of the materials enables picking and placing with a rolling action at predetermined locations while central eccentrically rotatable multi-sided gripper 140 maintains continuous orbital motion. Because central assembly system 114 employs continuous rotary motion, z-fold stacker machine 100 is capable of high throughput, high efficiency, and reduction of the high forces and vibrations associated with reciprocating motion.

In some embodiments, to maintain the overall throughput of the factory, a completed stack assembly is rapidly removed and replaced by and identical stack elevator assembly by means of a linear shuttle transverse to the feed direction. This optional shuttle maximizes the utilization of the stacking process. Downstream process steps (e.g., wrapping, taping, and other steps) can then be done in parallel with building the subsequent stack.

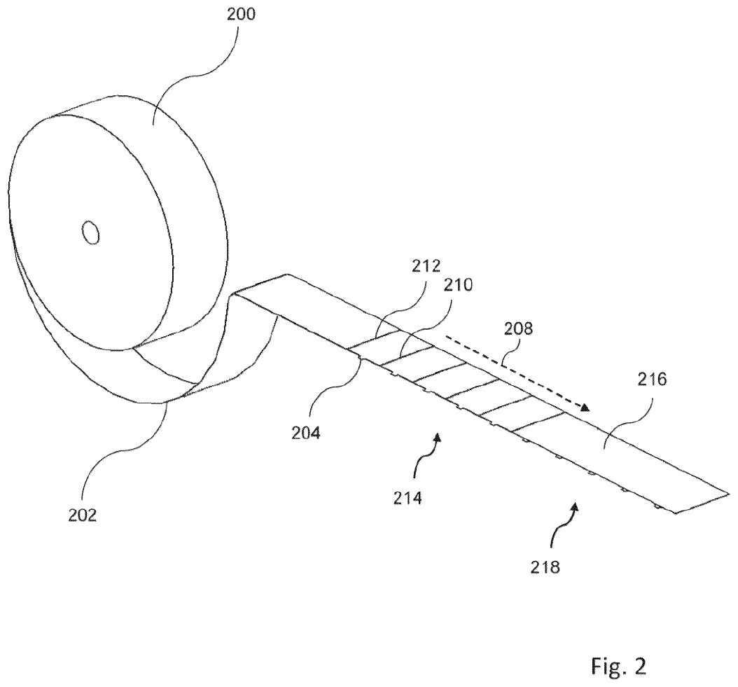

FIG. 2 shows an example of processing of an unprocessed electrode supply roll 200. As electrode web material 202 is unspooled from unprocessed electrode supply roll 200, it is conveyed to a notching and perforation station (e.g., a laser or punch, not shown). This station defines the shape of discrete electrodes, which may include notching a distal tab 204 and perforating peripheral lines of tearable holes 210,212 that are transverse to a transport direction 208 of electrode web material 202. The perforating is also referred to as fabricating tear lines for the electrode. Each of the tearable holes 210, 212 may be a partial perforation of the web, or it may be a through hole perforation through the entire web.

For each electrode, peripheral lines of tearable holes 210, 212 include a first line 210 toward a leading portion of electrode web material 202 and a second line 212 toward a trailing portion of electrode web material 202. Skilled persons will appreciate that each line in peripheral lines of tearable holes 212 may be generated individually or simultaneously with other lines or tabs. In some embodiments, the step of fabricating tear lines may also comprise laser ablating the web along the tear lines. This may be done as the step of performing the perforation, or it may be done in addition to another perforation process using e.g. a punch.

After the notching and perforation process, uncoated and non-singulated electrodes 214 may be coated (all but distal tabs 204) with the electrode graphite coating 216 to form coated and non-singulated electrodes 218. As is shown in FIG. 2, the coating may cover the perforation lines. Coated and non-singulated electrodes 218 are then optionally re-spooled for later supplying a stacker machine 100 or are immediately fed to a stacker system. In other embodiments, perforation may occur after coating. And in other embodiments, coating is optional (e.g., uncoated lithium foil). The singulation device may in some embodiments be a part of the stacker machine or stacker system.

While perforating the raw copper or aluminum foil (8 μm and 12 μm thick, respectively), any resultant burrs (spikes) are subsequently covered by the graphite coating process (which is on the order of 100 μm thick on either side). Thus, any spikes from perforation are rendered irrelevant since they would not protrude beyond the top surface of the electrode, e.g., not beyond a 10 μm specification.

In other embodiments, perforations may be cleaned and inspected prior to electrode coating. This can ensure that all of the incoming material is good and does not have overhanging punch protrusions. For example, the perforated metal may be passed through a set of rollers that flatten any out-of-plane protrusions to realign (squish) them into the plane. This calendering step may in some embodiments also be performed after coating.

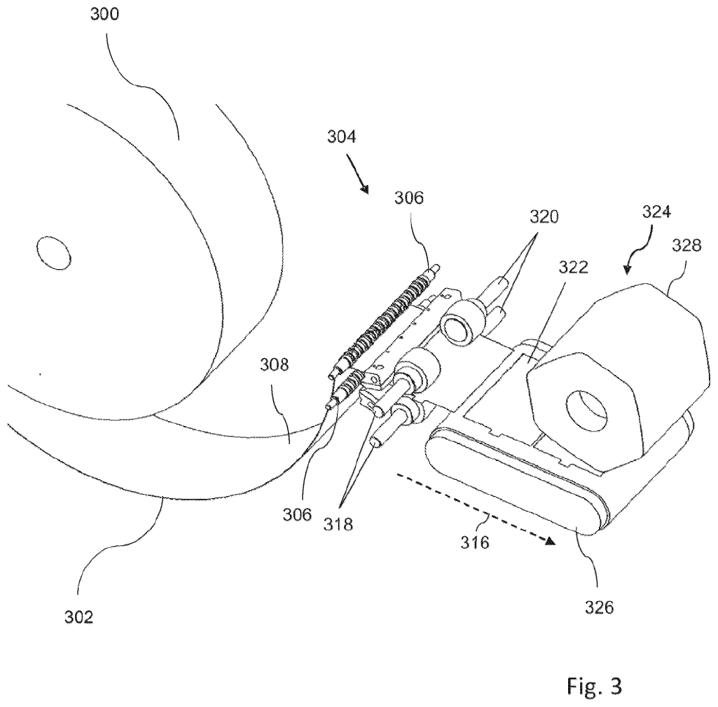

FIG. 3 shows an example of singulation assembly of a processed electrode supply roll 300, which in some embodiments is first roll 120 (FIG. 1) or second roll 128 (FIG. 1). In this example, processed electrode supply roll 300 includes coated and non-singulated electrodes 218 (FIG. 2) that have been respooled. In other words, pre-notched, perforated, coated, and non-singulated material 302 is fed from processed electrode supply roll 300 to a singulation device 304, which in some embodiments is singulation device 124 (FIG. 1) or singulation device 132 (FIG. 1).

Singulation device 304 includes feed rollers 306 that pull material 302 from the electrode supply roll 300, which may include a slack loop 308 that provides tension relief and enables roll 300 to feed at near constant feed rate. The feed rollers 306 may be positioned close to each other with the web material pressed tightly between them. Tear and position rollers 318, 320 accelerate a non-singulated electrode away from a trailing portion perforated line (not shown), which applies to material 302 a tearing force along a transport direction 312 to thereby singulate, along a singulation line, a coated electrode from material 302. This reduces the likelihood of producing problematic burs or spikes from a planar surface compared with a cutting process.

Tear and position rollers 318, 320 optionally include a set of independently driven rollers, such as a tab-side roller 318 and a flat-side roller 320. The tab-side roller 318 and flat-side roller 320 may be driven independently of each other. The tab side roller 318 and/or the flat-side roller 320 may each comprise a pair of rollers. In some embodiments, the top and bottom rollers on each side are coordinated with each other, which may entail that they run at the same speed. Because these rollers 318, 320 are independently driven, each roller can spin at different speeds to thereby twist and align a coated and singulated electrode 322 as it exits singulation device 304 and enters an infeed stacking location 324. In this example, infeed stacking location 324 includes a vacuum conveyor 326 to convey coated and singulated electrode 322 to a picking device 328 that is a subject of U.S. Provisional Patent Application No. 63/380,359, filed Oct. 20, 2022. The picking device 328 may be adapted to pick up a singulated electrode using vacuum, and transport it to a battery stack.

In other embodiments, the perforation tear and precision alignment of the singulated electrode could also be performed by other mechanisms such as a cross axis actuator positioning the rollers that are gripping the singulated electrode.

Singulation device 304 may in some embodiments also include an air knife or rotary brushes. These optional components reject debris generated during singulation.

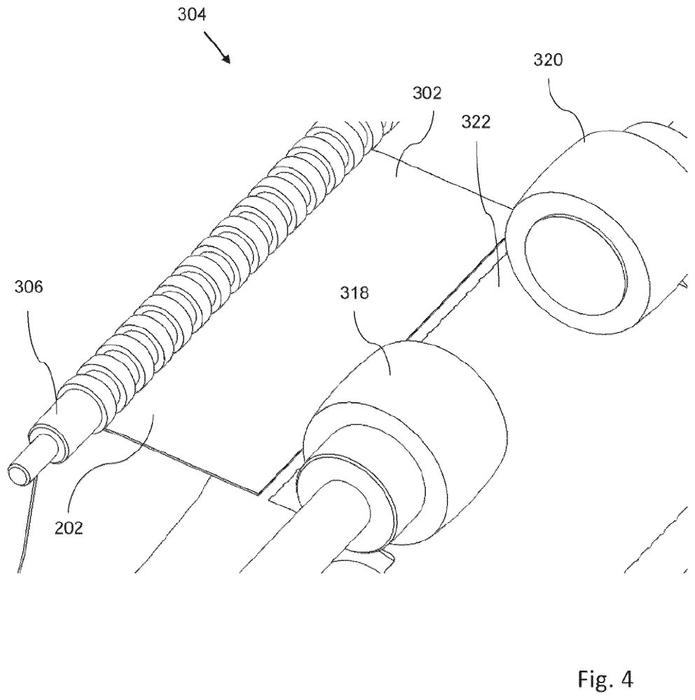

FIG. 4 shows in greater detail singulation device 304 while tearing a coated and singulated electrode 322 from material 302 of processed electrode supply roll 300 (FIG. 3).

Feed rollers 306 pinch electrode material 302 between top roller 306 and bottom roller (not shown), which may be driven by a controllable servo motor. In this example, feed rollers 306 nominally feed material 302 at the same speed as that of tear and position rollers 318, 320. Once coated and non-singulated electrode 218 (FIG. 2) is feed into tear and position rollers 318, 320, however, either feed rollers 306 or tear and position rollers 318, 320 change speed relative to the other roller. For instance, feed rollers 306 may decelerate or tear and position rollers 318, 320 may accelerate, thereby tearing coated and singulated electrode 322 at and/or along peripheral lines of tearable holes 212 (FIG. 2) to establish its singulation line. In some embodiments, to slow down feed rollers 306, the top and bottom roller pairs are synchronized either mechanically or with the control system.

In some embodiments, the speed of the feed rollers 306 are in the range of 50-950 mm per second, commonly in the 250-600 mm range. The difference in speed between the feed rollers and the tear and position rollers 318, 320, in a process of singulating an electrode, range from a very low difference up to 5-10 times the speed, depending on implementation. In some embodiments, the tear and position rollers 318, 320 are running at least 1.5× as fast as the feed rollers 306. In some embodiments, the tear and position rollers are running at 2-5 times the speed of the feed rollers, at the time of tearing and singulating an electrode. The acceleration from running at the same speed as the feed rollers to running at the increased speed may happen during a time period of 0.1-1 seconds.

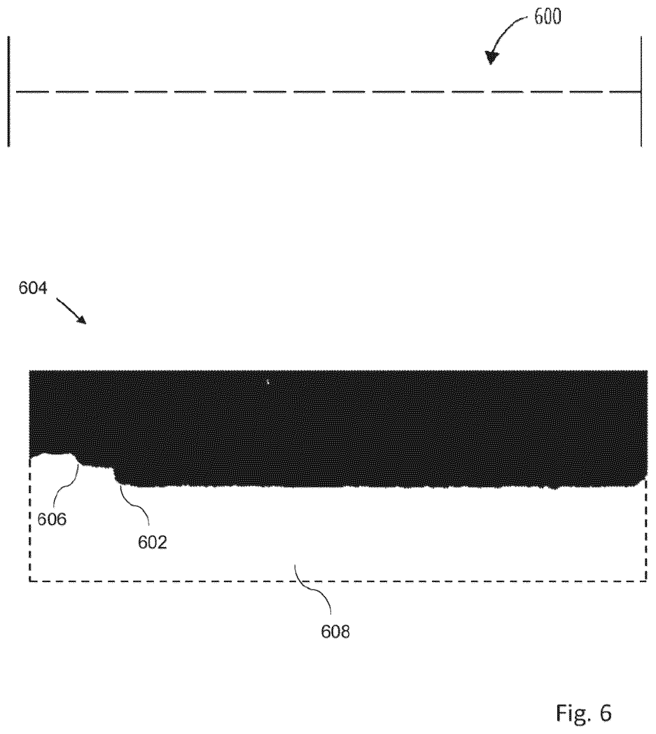

In experiments conducted to quantify the applied forces and speeds capable of tearing the material, the tearing force was found to be on the order of a few pounds across the width, which may be approximately 6 inches, which amounts to roughly 0.1 pounds per inch. The amount of force, however, may be readily tuned with the perforation patterns (see, e.g., patterns shown in FIG. 6-FIG. 8). It is believed that the tearing strength may be approximately three times the local web tension and approximately one third of the non-perforated web failure strength. More generally:

{Web Feed Tension+Margin}<{Tear Force (perforated)}<{Failure Force (unperforated)+Margin}

where “Failure Force” of the unperforated material is understood as the yield force and not necessarily the tear force. Yield (stretch) on other areas of the electrode while tearing at the perforation is to be avoided. The foil material may be perforated to tear at very low tensions, and this can be adjusted to be near the full web yielding tension.

In some embodiments, tab-side roller 318 and flat-side roller 320 are independent to enable them to start the tear at one edge and allow it to progressively separate across the web. This also enables precision positioning of coated and singulated electrode 322 on the vacuum conveyor or other transport device. For example, in case the web is misaligned relative to the position the electrodes are intended to have when being picked, the tab-side roller 318 and/or the flat-side roller 320 can be used in order to position the singulated electrode correctly, by increasing the speed of one of the rollers relative to the other.

As noted previously, the perforation tear and precision alignment of the singulated electrode could also be performed by other mechanisms such as a cross axis actuator positioning the rollers that are gripping the singulated electrode.

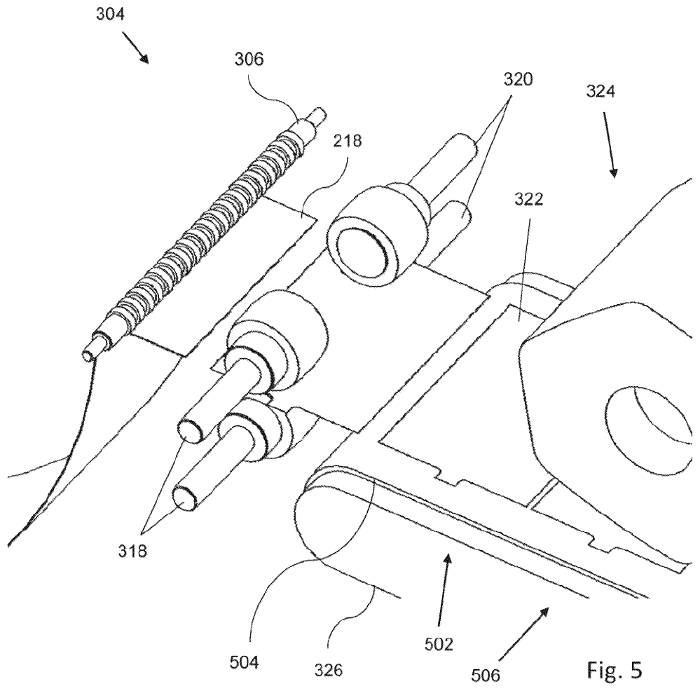

FIG. 5 shows in greater detail electrode alignment for infeed stacking location 324. Tear and position rollers 318, 320 advance coated and singulated electrode 322 onto vacuum conveyor 326 toward a transport position 502. Vacuum conveyor 326 issues a positive air outflow to ensure that coated and singulated electrode 322 floats freely above a conveyor surface 504.

After the electrode has been singulated and aligned on vacuum conveyor 326, the pressure switches to vacuum to secure the singulated electrode to conveyor surface 504. This may occur near or at the next stopped position while the downstream electrode is getting picked (i.e., transferred to the picking device). This transfer from roller control to vacuum belt control is coordinated as the electrode leaves the grip of the rollers.

In some embodiments, the picking device 324 is adapted to pick up the electrode using vacuum. This process may be coordinated with releasing the vacuum applied by the conveyor 326, such that the conveyor starts releasing the vacuum for the front part of the electrode in the transport direction, and that the picking device starts applying vacuum to the same part of the electrode, and then this gradually continues until the conveyor 326 has completely stopped applying vacuum on any part of the electrode, and that the picking device 324 applies vacuum on the entire electrode.

Tear and position rollers 318, 320 then match the speed of vacuum conveyor 326 as it advances coated and singulated electrode 322 for the next incremental movement toward a pick position 506, until coated and singulated electrode 322 leaves contact with tear and position rollers 318, 320. Next, tear and position rollers 318, 320 matches its speed to that of feed rollers (only one shown) 306 to engage a following coated and non-singulated electrode 218, then as the perforated edge comes out of the feed rollers, the tear and position rollers accelerate in order to tear the electrode along the perforation, before again matching the speed of the vacuum conveyor 326. Vacuum conveyor 326 then advances one increment for moving coated and singulated electrode 322 from transport position 502 to pick position 506.

FIG. 6-FIG. 8 show examples of, respectively, dashed, scalloped, and trapezoidal shaped perforation lines and resulting tears, which may be used in different embodiments. The web material for the electrode may be different in different embodiments, but the experimental results underlying FIGS. 6-8 were obtained using uncoated aluminum material. In each example, the perforation line is formed by a plurality of through-holes linearly disposed along the transverse direction of the web. The through-holes and portions at which the through-holes are not formed are alternately disposed. By changing the sizes, the intervals, and the like of the through-holes, tearing characteristics of the perforation lines may be controlled. The shape of the through-hole is not particularly limited, and for example, a perfect circular shape, an oval shape, a long hole shape, a thin line shape, or other shapes may be used. Moreover, partial cuts or scoring on one or both sides may also be employed.

During experimentation, the trapezoidal shaped was the easiest to tear, followed by the scalloped shape, and then the dashed shape. Skilled persons will appreciate, however, these results may vary based on the web width, spacing of perforations (i.e., unperforated material), and volume of perforation.

Perforation percentage may also be adjusted to tune the tear strength of the web. Preferably, the perforation is such that it covers a majority of the web, although in some embodiments it may be lower. The perforation percentage may be anywhere between IO-99%. In some embodiments, the perforation is somewhere between 50-99%, in some embodiments it's 70-98%, in some embodiments it's 80-95% and in some embodiments it's 90-95% of the entire web at the tear position. There is a balance between having enough perforation to enable a smooth tearing process, and not having so much perforation that the web starts falling apart before the singulation is performed.

When laser cutting coated electrodes, the electrode layer typically needs the greatest amount of cutting energy, whereas cutting the coating uses significantly less energy. And if the laser intensity is reduced, it may still remove the coating, which is useful in some embodiments to reduce particles near the coating edge that crumbles during tearing. By modulating laser intensity during perforation, the perforation line can include a combination of through holes and scoring (e.g., scoring through the coating only). Accordingly, since the coating is completely cut and the foil is perforated, the tearing may then become a metal-only tear, thereby reducing coating particles that would otherwise be generated. Because singulation may be achieved using perforations (through hole or partial), scoring (on one or both sides), and any combinations thereof, this disclosure generically refers to the results of any of them as a fabricated tear line. In some embodiments, the electrode is perforated before any coating is applied, and no perforation or scoring of the coating is performed.

FIG. 6 shows details of dashed shaped perforations. Specifically, an upper portion of FIG. 6 shows a dashed shaped perforation line 600, which may be used for perforation in some embodiments. The lower portion of FIG. 6 shows an enlarged tear 602 in a singulation line 604 formed by tearing dashed shaped perforation line 600, but wherein the shape of each dash is slightly different. This shape results in relatively rectangularly shaped lateral protrusions 606 along singulation line 604 where material 608 breaks away from the web.

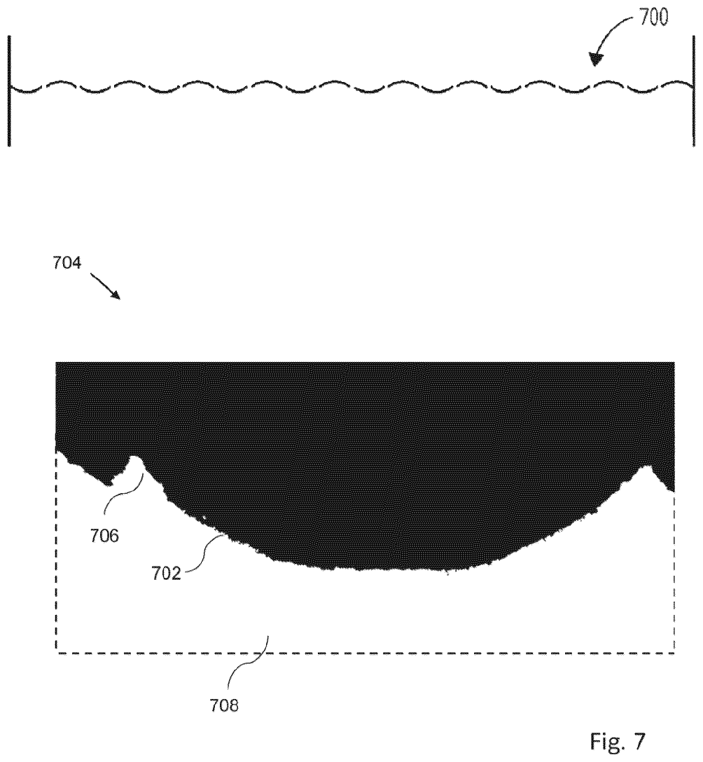

FIG. 7 shows details of scalloped shaped perforations. Specifically, an upper portion of FIG. 7 shows a scalloped shaped perforation line 700, and a lower portion of FIG. 7 shows an enlarged tear 702 in a singulation line 704 formed by tearing one type of scalloped shaped perforation line 700. This shape results in relatively triangularly shaped lateral protrusions 706 along singulation line 704 where material 708 breaks away from the web.

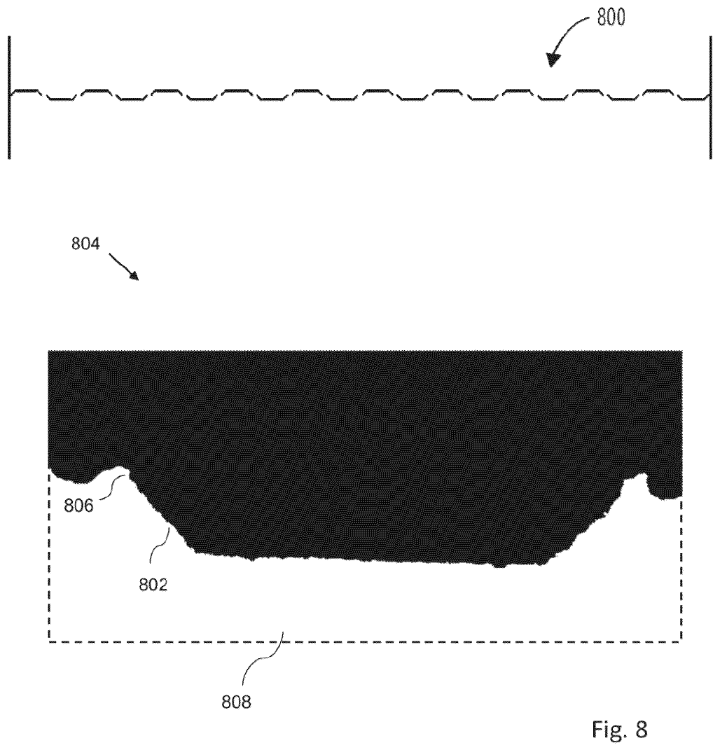

FIG. 8 shows details of trapezoidal shaped perforations. Specifically, an upper portion of FIG. 8 shows a trapezoidal shaped perforation line 800, and a lower portion of FIG. 8 shows an enlarged tear 802 in a singulation line 804 formed by tearing one type of trapezoidal shaped perforation line 800. This shape results in relatively triangularly shaped lateral protrusions 806 along singulation line 804 where material 808 breaks away from the web.

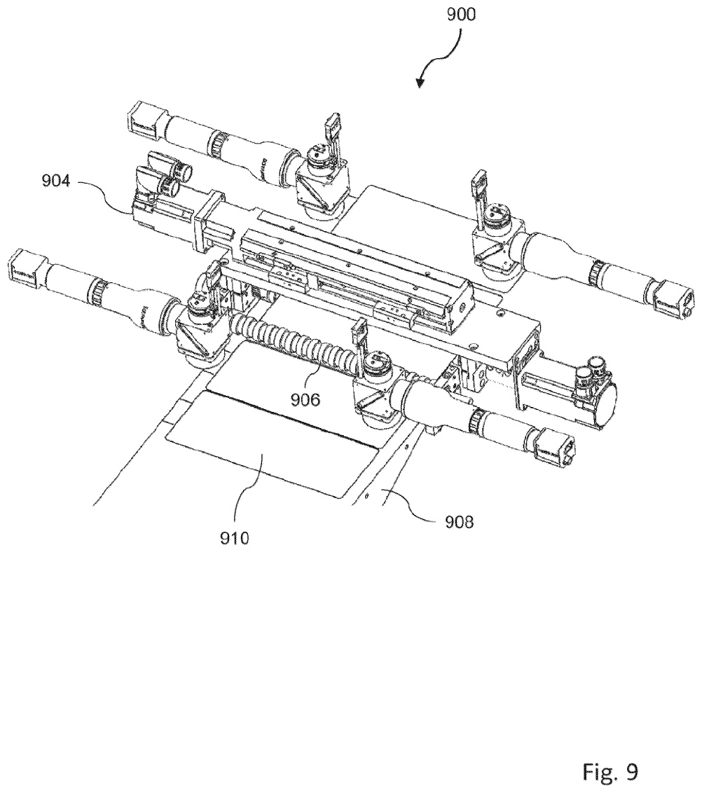

In the examples of FIG. 6-FIG. 8, the perforations are fairly uniform. In other embodiments, the perforations may be non-uniform. For instance, some embodiments may include more perforations in an area where the initial tear is desired. In one example, a tear-start portion is provided as triangle-shaped notch at an end of a fabricated tear line so that the tearing motion may be started at the notch by accelerating one side of the electrode before the other and then catching up with the other side to re-center the electrode. Accordingly, instead of a straight tearing motion along the transport direction, other tearing directions are also contemplated. For example, a progressive tear (see, e.g., FIG. 5 but starting at one edge and progressing across the electrode), a shearing tear (see e.g., FIG. 9, moving the electrode in the cross-axis direction), an impact surface acting nominally perpendicular to the web to impact the surface of the perforations and thereby initiate the tearing action, or some combination of tearing configurations.

FIG. 9 shows a singulation device 900, according to another embodiment. Singulation device 900 is configured to facilitate a lateral shift, via roller pairs 902 that tears electrodes along the fabricated tear line. In the example of singulation device 900, a linear stage 904 shifts one edge of an electrode 910 and reacts against a stationary roller 906 shown above an infeed conveyor 908. Roller pairs 906 includes an upper roller that is spring tensioned to apply a downward force atop electrode 910 and pinch it against a fixed lower roller. In some embodiments, once the tear is complete, linear stage 904 also performs fine lateral positioning of electrode 910 prior to stacking.

In some embodiments, an impact device is positioned at a location where the tear is to be initiated, which may be in close to or in the center of the web and/or of an electrode. The impact device extends upwardly out of the plane of the web material. The rollers move the fabricated tear line over the impact device, and accelerate or decelerate the material so that any slack near the fabricated tear line is tensioned, which forces the perforation along a blunt side of the impact device. This blunt side forces a tear in the perforation. For instance, after an electrode enters the downstream roller pair, this pair accelerates the electrode creating tension in the vicinity of the impact device as the electrode is pulled towards the impact device in the middle of the electrode near a fabricated tear line. This will initiate a tearing at the center of the electrode, which will propagate towards the edges until is fully singulated.

The impact device may include a convex surface. Other types of impact devices may include edges. Furthermore, another impact device may be moved relative to the electrodes (i.e., a chop action) to perform the tear.

Skilled persons will appreciate that many changes may be made to the details of the above-described embodiments without departing from the underlying principles of the invention. The scope of the present invention should, therefore, be determined only by claims and equivalents thereof.

What is claimed is:

1. A method of singulating electrodes, comprising:
fabricating tear lines between adjacent electrodes in a web; feeding the web through a singulation device; and
applying with the singulation device a force to the web so as to tear from it an electrode along its fabricated tear line.

2. The method according to claim 1, further comprising:
coating the web with a coating material, prior to feeding the web through the singulation device.

3. The method according to claim 1, wherein applying the force comprises accelerating the electrode that is to be torn from the web relative to the web, along its fabricated tear line.

4. The method according to claim 1, wherein the step of fabricating the tear lines is performed at a different location than the step of feeding and applying the force.

5. The method according to claim 1, wherein the applying comprises applying a tearing force that is approximately a third of the web failure strength, and approximately three times the local web tension.

6. An electrode singulation system to singulate electrodes from a web, the system comprising:
feed rollers to feed web material from a roll;
tear and position rollers that receive a portion of the web material from the feed rollers; and
a controllable motor to change speed of at least one of the feed rollers and tear and position rollers to thereby generate a tearing force, applied to a fabricated tear line along the web material, and singulate the portion of web material according to a predefined shape of an electrode.

7. The electrode singulation system according to claim 6, further comprising:
a perforation device adapted to fabricate tear lines between adjacent electrodes in the web.

8. The electrode singulation system according to claim 6, further comprising: a conveyor, adapted to transport an electrode after it has been singulated; and a picking device, adapted to pick a singulated electrode from the conveyor and transport it to a battery stack.
